(19) United States
(12) Patent Application Publication
(10) Pub. No.: US 2005/0195116 A1
(43) Pub. Date: Sep. 8, 2005

(54) Slot antenna

(75) Inventors: Norbert Lotterer, Eningen (DE); Juergen Von Hagen, Karlsruhe (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler, Stuttgart (DE)

(21) Appl. No.: 11/063,582

(22) Filed: Feb. 24, 2005

(30) Foreign Application Priority Data
Feb. 24, 2004 (DE) 10 2004 008 973.6

(51) Int. Cl. H01Q 1/32

(52) U.S. Cl. 343/713; 343/767

(57) ABSTRACT

A slot antenna is formed between two body parts of a vehicle, with an antenna signal being tapped at an antenna signal tap point. One body part is capacitively coupled to a conductor of a radio frequency cable or a radio frequency connecting plug.

### BACKGROUND AND SUMMARY OF THE INVENTION

This application claims the priority of German patent document no. 10 2004 008 973.6, filed Feb. 24, 2004, the disclosure of which is expressly incorporated by reference herein.

The invention relates to a slot antenna which is formed between two body parts of a vehicle, with an antenna signal being tapped at an antenna signal tap point.

Slot antennas for motor vehicles are known. (See, for example, European patent documents EP 0 382 901 A2 and DE 40 00 381 A1.) In particular, it is known to form a slot in the vehicle body, for example for car radio reception, as an integrated component of the body. An existing body joint in the region of the hood or door of the vehicle, for example, can be used as a slot for the slot antennas, or the slot can be made in a body surface, such as the roof of the vehicle. Due to resonance effects, high field strengths occur particularly at gaps, and can be used to derive strong antenna signals.

International patent document WO 93/03507 discloses a vehicle slot antenna produced by forming a gap between parts of the vehicle body; for example between a rigid vehicle cell and a moveable body part such as a door, a trunk lid or an engine hood. An antenna signal tap point is provided for tapping the antenna signal, with an RF connecting plug being electrically connected to a moveable body part by means of a plug-type contact. Such a plug type contact, however, is at risk of contamination, and although a d.c. contact is required, it cannot be ensured.

One object of the present invention is to provide a vehicle slot antenna which permits a contamination proof power tap and with which contact can be made in a contamination-proof fashion.

This and other objects and advantages are achieved according to the invention, by a slot antenna of the type mentioned previously, in which a body part is coupled capacitively to a conductor of a radio frequency cable or an RF connecting plug. The capacitive coupling allows a contamination proof contact to be made with the slot antenna, and provides a contamination proof power tap. The tapped antenna signal is adversely affected to only an insignificant degree by the facts that contact is made with the slot antenna in a capacitive fashion, and that the antenna is coupled capacitively. However, care must be taken to minimize the distance between the body part which is capacitively connected to the conductor of the radio frequency cable, and the conductor or a part which is electrically connected thereto. The other body part can be connected via a d.c. contact to a further conductor of the radio frequency cable or to the RF connecting plug. As a result of the arrangement according to the invention it is possible for the slot antenna not to be seen as an additional component. Furthermore, it is also possible to provide an antenna for vehicles without a rear windshield.

In a preferred embodiment of the invention, the capacitive coupling is carried out via a first spacer which sets a defined distance between the body parts and is arranged on a body part. Spacers are provided in any case between a large number of body parts. For example, in many vehicles a spacer (referred to as a buffer) is located between the rigid vehicle body and the engine hood in order to slow down the engine hood as it closes and to avoid vibrations during travel. Such spacers, which are already present or which can be installed subsequently, can be used for capacitive coupling. In this context, the spacer is arranged or attached at one end to one of the body parts. For the capacitive coupling, the spacer must be electrically insulated from the body part on which it is arranged or to which it is attached. In particular, if the capacitive coupling is implemented by a spacer which is already present, it is possible to leave the body parts completely unaffected so that the manufacturing expenditure on slot antennas according to the invention is extremely small.

In one preferred embodiment, at least one capacitive short circuit can be provided between the body parts. The conductive connections (for example hinges or locks) ideally constitute a short circuit when they are active at radio frequencies, thus bringing about a defined distribution of current around the gap and a defined field distribution in the gap. However, the ideal case of a short circuit via the hinges and/or locks is usually not present since a hinge or a lock constitutes an undefined impedance which is difficult to reproduce. As a result, the defined antenna function of the gap can be adversely affected.

To deal with this problem, it is possible, inter alia, to provide a capacitive short circuit connection between the body parts forming the gap for the slot antenna, thus ensuring a defined, reproducible short circuit connection. A defined impedance which is thus achieved also gives rise to a reproducible, uniquely defined antenna function of the gap. The construction of a capacitive short circuit has the advantage that it is contamination proof, in contrast with the prior art. The antenna is adversely affected either insignificantly or not at all, by contamination of contacts.

It is particularly advantageous if the capacitive short circuit is formed by means of a second spacer which is arranged on a body part. (As already mentioned, spacers are frequently present in any case in a vehicle.) Such spacers may be used as capacitive short circuit connections. Furthermore, it is possible without a large degree of expenditure to arrange further such spacers in a vehicle.

In one preferred embodiment of the invention the first or second spacer to has an electrically conductive part, and an elastic (in particular, electrically insulating) material is arranged between one free end of the spacer and the other body part on which the spacer is not arranged, or to which it is not attached. The electrically conductive part forms a connection to an RF cable or an RF connecting plug at the first spacer, and a connection to the other body part is formed at the second spacer. The elastic material (in particular, a material layer) defines the distance between the body part which is to be coupled capacitively and the free end of the conductive part of the spacer. The elastic material also causes the body part to be damped and spring mounted. The elastic material layer, and thus the free end of the spacer, is preferably arranged in the vicinity of the slot, for example at the edge of the slot.

In one preferred embodiment, the electrically conductive part of the spacer has the elastic electrically insulating material at least on a side facing the other body part. This means that the electrically conductive part of the spacer is coated by the elastic material (in particular rubber) on which the body part to which the spacer is not attached can rest.

In an alternative embodiment, the other body part has the elastic electrically material at a location facing the spacer. For example, the elastic material may be arranged on the underside of an engine hood or of the lid of a trunk. It is apparent that the elastic material should be relatively thin in order to bring about good capacitive coupling or a good capacitive short circuit.

It is particularly preferred if the spacer has a head part with a large surface, ensuring good supporting contact with the other body part, and permitting good capacitive coupling.

A very good capacitive coupling or a good capacitive short circuit can be implemented if the spacer is constructed with a T-shaped cross section.

It is also advantageous if the first spacer is connected by its electrically conductive part to a first conductor of an RF cable, and the body parts are connected to a second conductor of the RF cable (such as a coaxial cable). This makes it possible for the antenna signal to be tapped between two locations which are opposite one another at the gap. Antenna signals can be tapped with a very high degree of antenna efficiency between two locations which are opposite one another at the gap. By corresponding positioning of the signal taps it is also possible to implement source impedances which permit very good adaptation to a radio frequency line so that adaptation networks and active components for equalizing the adaptation losses can be dispensed with.

The capacitive short circuit is implemented in a simple way if the second spacer is electrically conductively connected to a body part by its electrically conductive part.

Advantageously, the slot antenna is constructed between a moveable body part and a rigid body part. For slot antennas it is possible to use basically any gap between parts of the vehicle body, even a gap between fixed parts of the vehicle body (for example, gaps between the mudguards and the vehicle cell). It is advantageous, however, if the slot antenna is formed by a gap between a rigid body part and a moveable body part (for example of a door, the lid of a trunk or the engine hood). Since such a gap is present in any case, it is particularly easy to provide slot antennas in this way, and to derive suitable antenna signals. By using capacitive short circuits and capacitive coupling of the slot antenna, it is ensured that the operator control and the function of the moveable body parts are not adversely affected by the presence of a slot antenna.

Basically any form of slot antenna is conceivable. In particular, depending on the conditions of the body parts the slot antenna may be either curved or linear. Advantageously, the slot antenna may be bounded by two short circuit connections, with at least one short circuit connection being constructed as a capacitive short circuit connection and the antenna signal tap point being arranged between the short circuit connections in such a way that the reactive component which is produced in the antenna signal as a result of the capacitive short circuit is compensated. This is especially advantageous with a linear slot antenna.

While the distance between the antenna signal tap point and the d.c. short circuit connection is essentially a quarter wavelength of the operating frequency in a linear slot antenna in the prior art, the tap point with a capacitive short circuit connection must be shifted in comparison. That is, the distance between the tap point and the capacitive short circuit connection or connections is to be selected in accordance with the optimization criterion for both a linear and a nonlinear slot antenna. Specifically, it is necessary to bring about a favorable impedance for the power adaptation to a radio frequency line or an amplifier input.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective illustration of a part of a vehicle with a slot antenna;

FIG. 2 is a perspective illustration of capacitive coupling of the slot antenna; and

FIG. 3 shows an embodiment of a capacitive short circuit.

### DETAILED DESCRIPTION OF THE DRAWINGS

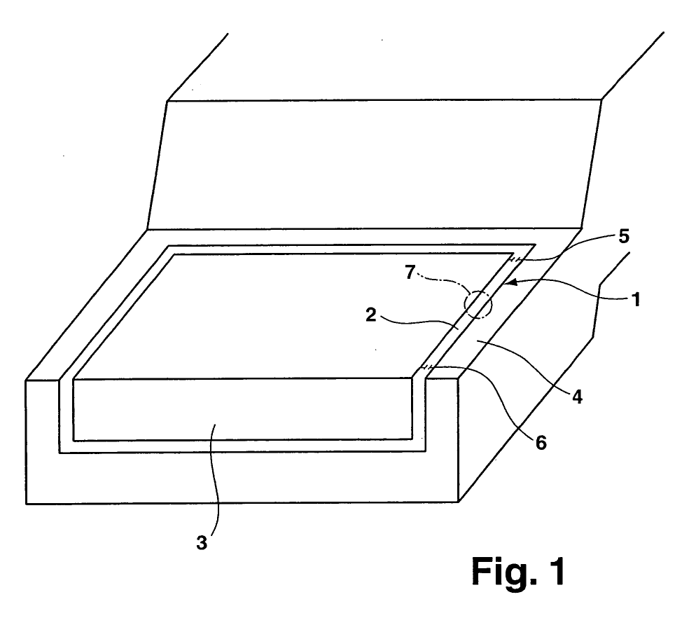

FIG. 1 shows a slot antenna 1 formed by a gap 2 which is located between a first body part 3 and a second body part 4, and is bounded by two capacitive short circuit connections 5, 6. The antenna signals are tapped at an antenna signal tap point 7. At least one of the body parts 3, 4 (preferably the body part 3 which is moveable in the exemplary embodiment) is capacitively connected to a radio frequency cable at the tap point 7. Thus, a d.c. contact with the body part 3 is provided in a simple manner, and the gap 2 needs not be spanned by a d.c. connection.

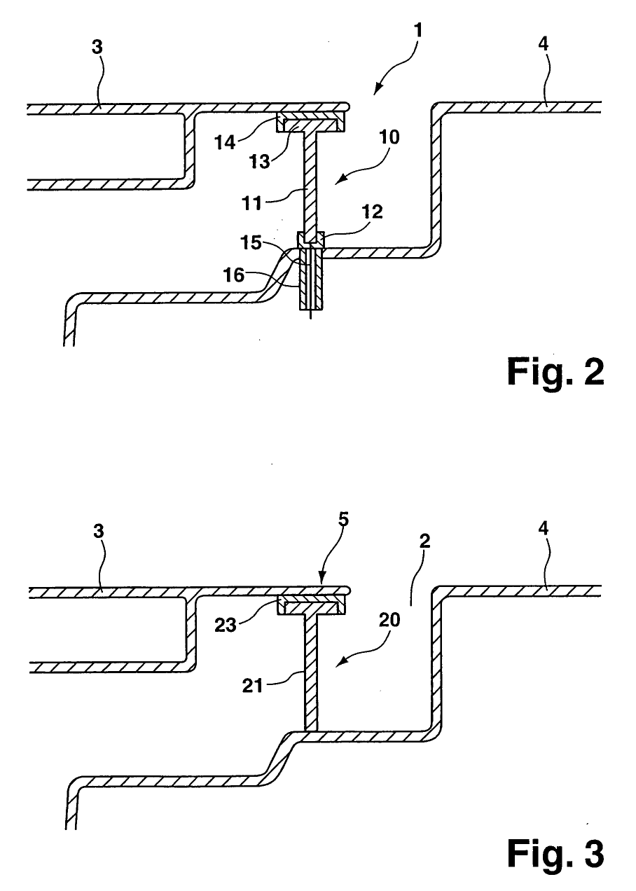

FIG. 2 illustrates the implementation of a capacitive connection of the slot antenna 1. A spacer 10 is arranged on (attached to) the body part 4, which is rigid in the exemplary embodiment. The spacer 10 has an electrically conductive part 11 which is electrically insulated from the body part 4 by an electrically insulating layer 12. The electrically conductive part 11 has a T-shaped cross section, with a head part 13 that is covered by an elastic material 14. The latter is thus arranged between the electrically conductive part 11 and the body part 3, and has a damping effect so that vibrations are prevented.

The material 14 establishes a defined distance between the electrically conductive part 11 and the body part 3. The T shaped configuration of the spacer 10, with the flat configuration of the head part 13, ensures that there is a large contact surface (and thus a large surface which is active for the capacitive coupling) between the spacer 10 and the body part 3. The electrically conductive part 11 is connected to a conductor 15 which is guided in an RF connecting plug 16. Contact between a further conductor (not illustrated) and the body part 4 is ensured by the RF connecting plug 16. For example, a coaxial cable can be plugged, with a corresponding connecting plug, onto the RF connecting plug 16 so that the RF line 15 is connected to a receiver and/or transmitter.

FIG. 3 shows a second spacer 20 which is of similar design to the first spacer 10. The only difference is that a capacitive short circuit is established between the body parts 3, 4 by the spacer 20. For this purpose, the electrically conductive part 21 is not electrically insulated from the body part 4 but is rather connected to it in an electrically conductive fashion. The spacer 20 also has a T-shaped cross section and has an elastic material 23 at its free end. The body part 3 rests on the elastic material 23. FIG. 3 clearly shows that the capacitive short circuit connection 5 is arranged at the edge of the gap 2 and at an edge of the body part 3, respectively.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A slot antenna comprising a gap between two body parts of a vehicle, with an antenna signal being tapped at an antenna signal tap point, wherein one of said body parts is capacitively coupled to a conductor of one of an RF cable and an RF connecting plug.

2. The slot antenna as claimed in claim 1, wherein the capacitive coupling is formed by means of a first spacer which establishes a defined distance between the body parts and is arranged on one of the body parts.

3. The slot antenna as claimed in claim 1, wherein at least one capacitive short circuit is provided between the body parts.

4. The slot antenna as claimed in claim 3, wherein the capacitive short circuit is formed by a second spacer which is arranged on one of said body parts.

5. The slot antenna as claimed in claim 4, wherein one of the first and second spacers has an electrically conductive part and an elastic electrically insulating part and is arranged between one free end of the spacer and the other body part.

6. The slot antenna as claimed in claim 5, wherein the electrically conductive part of the spacer has the elastic electrically insulating material at least on a side facing the other body part.

7. The slot antenna as claimed in claim 5, wherein the other body part has the elastic electrically insulating material at a location facing the spacer.

8. The slot antenna as claimed in claim 7, wherein the spacer has a head part.

9. The slot antenna as claimed in claim 7, wherein the spacer is constructed with a T-shaped cross section.

10. The slot antenna as claimed in claim 9, wherein:
the first spacer is connected by its electrically conductive part to a first conductor of an RF cable; and
one of the body parts is connected to a second conductor of the RF cable.

11. The slot antenna as claimed in claim 10, wherein the second spacer is connected in an electrically conductive fashion by its electrically conductive part to a body part.

12. The slot antenna as claimed in claim 11, wherein the slot antenna is formed between a moveable body part and a rigid body part.

13. The slot antenna as claimed in claim 12, wherein:
the slot antenna is bounded by two short circuit connections, with at least one short circuit connection being constructed as a capacitive short circuit connection; and
the antenna signal tap point is arranged between the short circuit connections in such a way that a reactive component produced in the antenna signal as a result of the capacitive short circuit is compensated.

14. A slot antenna, comprising:
a first metallic body part of said vehicle;
a second metallic body part of said vehicle, which is separated from said first body part by a gap that forms a slot of said slot antenna;
wherein, one of said first and second body parts is capacitively coupled to an RF conductor as a signal tap.

15. The slot antenna as claimed in claim 14, wherein the capacitive coupling is formed by means of a first spacer which establishes a defined distance between the body parts and is arranged on one of the body parts.

16. The slot antenna as claimed in claim 15, wherein at least one capacitive short circuit is provided between the body parts.

17. The slot antenna as claimed in claim 16, wherein the capacitive short circuit is formed by a second spacer which is arranged on one of said body parts.

18. The slot antenna as claimed in claim 17, wherein one of the first and second spacers has an electrically conductive part and an elastic electrically insulating part and is arranged between one free end of the spacer and the other body part.

19. The slot antenna as claimed in claim 18, wherein the electrically conductive part of the spacer has the elastic electrically insulating material at least on a side facing the other body part.

20. A vehicle body comprising:
at least a first metallic body part and a second metallic body part;
a slot antenna formed in said vehicle body by a slot comprising a defined gap between said first and second body parts; and
a signal tap which comprises an RF conductor that is capacitively coupled to one of said first and second metallic body parts.
